(19) United States
(12) Patent Application Publication
(10) Pub. No.: US 2018/0187123 A1
(43) Pub. Date: Jul. 5, 2018

(54) Perfume Compositions

(71) Applicant: GIVAUDAN SA, Vernier (CH)

(72) Inventors: Robin CLERY, Horgen (CH); Sandro DOSSENBACH, Gossau (CH); Dominique LELIEVRE, Kindhausen (CH); Boris SCHILLING, Knonau (CH)

(21) Appl. No.: 15/757,067

(22) PCT Filed: Sep. 23, 2016
(86) PCT No.: PCT/EP2016/072698

§ 371 Date: Mar. 2, 2018

(30) Foreign Application Priority Data
Sep. 24, 2015 (GB) 1516911.3

(51) Int. Cl. C11B 9/00

(52) U.S. Cl. CPC C11B 9/0092; C11B 9/0096; C11B 9/008; C11B 9/0076; C11B 9/0011; C11B 9/0053; C11B 9/0034; C11B 9/003; C11B 9/0019; C11B 9/0061

(57) ABSTRACT

A perfume complement comprising one or more compounds selected from compounds present in the fraction of patchouli oil having a Kovats Retention Index on a DB-5 column of 1500 or lower and/or olfactively equivalent perfume ingredients

### FIELD OF THE INVENTION

This disclosure relates to perfume compositions and perfume ingredients useful therein.

### BACKGROUND TO THE INVENTION

Patchouli, an essential oil obtained by steam distillation of the leaves of the patchouli plant (Pogostemon cablin) native to Asia, is a popular fragrance ingredient. The main constituents of the oil are reportedly β-patchoulene, α-guaiene, caryophyllene, α-patchoulene, seychellene, α-bulnesene, nor-patchoulenol, patchouli alcohol and pogostol. Its heavy, distinctive scent has been valued for centuries.

There have been many attempts to reproduce the odour of patchouli oil. However, as it is universally regarded that the sesquiterpenoid ingredients contained in patchouli oil are responsible for the heavy, woody, substantive characteristic odour, perfumers have focused their attention on combinations of terpenes and olfactively similar perfumery ingredients in search of the particular fragrance attributes observed in patchouli oil. Accordingly, whereas this orthodox approach to perfume design mimics the odour of patchouli oil to some extent, it does not quite achieve the oil's nuanced hedonic effect.

In an alternative approach, advanced fermentation techniques have been employed to make synthetic patchouli oils. Sesquiterpene synthases and their use in the preparation of biosynthetic patchouli oils have been described in WO 2005/052163. An example of such a product, Clearwood™ (see Technical Disclosure, IP.com Number IPCOM000233341D), is rich in patchoulol and is reportedly capable of partially or completely substituting for patchouli oil in various technical and fine perfumery applications. While Clearwood™ is stated to possess “all the noble notes of fresh patchouli”, it is also stated to be distinguishable from the natural oil “in particular by its having a less pronounced earthy, camphoraceous, spicy and leather character”.

Thus, the results of these various endeavours to reconstitute the complex odour of patchouli oil are products that whilst being somewhat reminiscent of patchouli oil, nevertheless lack its distinctive fragrance characteristics. Accordingly, whilst these products cannot truly replace patchouli, they can be used to dilute or “extend” patchouli oil, and as such they are hereinafter referred to as “patchouli extenders”. A true synthetic replacement for patchouli oil, however, remains elusive.

There remains a need to provide perfume compositions (hereinafter “perfume complements”) containing ingredients or combinations of ingredients that can be added to fragrance formulations, such as extenders, to adapt, improve or modify them such that their odour more closely resembles the uniquely characteristic odour of patchouli oil.

If patchouli oil is analyzed by gas chromatography, the GC trace reveals the characteristic diverse profile of sesquiterpenoids that are regarded as being responsible for its odour and certain other peaks corresponding to compounds that are of no olfactive interest. Therefore, beyond confirming the characteristic odour profile of the sesquiterpenoid compounds, conventional GC olfactometry has proven to be ineffective in helping the perfumer to reach a deeper understanding of the chemical constituents responsible for the finer odour nuances of patchouli oil.

However, rather than analyzing patchouli oil by conventional GC olfactometry, the applicant carried out static head space collection on a sample of patchouli oil, and subjected the head space, rather than the oil, to GC analysis. The applicant was surprised to find a series of peaks, not detectable on a standard GC trace of patchouli oil, which corresponded to a series of highly volatile compounds that have never been described in patchouli oil to the best knowledge of the applicant. Furthermore, these compounds, despite their very high volatility and being present in vanishingly low levels, were found to be significant contributors to some of the odour nuances of patchouli oil.

### SUMMARY OF THE INVENTION

The present invention provides in a first aspect a perfume complement comprising one or more compounds selected from compounds present in the fraction of patchouli oil having a Kovats Retention Index on a DB-5 column of 1500 or lower and/or olfactively equivalent perfume ingredients.

In another aspect of the invention there is provided a fragrance composition comprising said perfume complement.

In yet another aspect of the invention there is provided a fragrance composition comprising said perfume complement and a patchouli extender.

In another aspect there is provided a method of adapting, modifying or improving the odour of a fragrance composition, such as a patchouli extender, said method comprising the step of adding the perfume complement to the extender.

In yet another aspect there is provided a consumer product comprising said perfume complement or said fragrance composition.

### DETAILED DESCRIPTION OF THE INVENTION

The invention is based on the surprising discovery that a highly volatile fraction of patchouli oil consisting of compounds having a Kovats Retention Index on a DB-5 column of 1500 or lower, which is undetectable on a standard GC trace of the oil, contains one or more ingredients that contributes significantly to the odour nuances of patchouli oil. Furthermore, some of these ingredients possess odours that would not immediately be associated with the odour of patchouli and as such, they enable perfumers to draw on their olfactive equivalents from perfumery ingredients that would not conventionally be considered to be relevant in the context of patchouli. In turn, this enables the preparation of perfume complements that are unique, differentiating and enable the perfumer to move closer to the true odour of patchouli.

The highly volatile fraction referred to herein above can be isolated in a number of ways. Fractional collection techniques include head space trapping, and fractional distillation techniques under various conditions of temperature and pressure.

In a particular embodiment of the invention, the fraction of patchouli oil having a Kovats Retention Index on a DB-5 column of 1500 or lower can be obtained by trapping the head space above a sample of patchouli oil. Thereafter, the trapped headspace can be analyzed by GC olfactometry and/or GC mass-spectrometry.

Head space trapping and analysis is a technique developed to elucidate the odour compounds present in the air surrounding various objects. Usually the objects of interest are objects that are valued for their highly volatile ingredients surrounding them, such as plants, flowers and foods.

In principle, after the head space is analyzed, the scents can then be recreated by perfumers, either by employing the compounds found in the head space, or by substituting them with similarly smelling perfume ingredients on the perfumer's palette.

As is known by the person skilled in the art, head space equipment involves a container which surrounds the sample of interest. Inert gases are passed into the space containing the object or a vacuum is established such that the volatile compounds are swept out of the head space and captured using a variety of techniques among them cold surfaces, solvent traps, and adsorbent materials, with the latter techniques capable of longer periods of collection. The samples can then be analyzed using techniques such as gas chromatography-mass spectrometry.

It was counter-intuitive to use fractional collection in the manner described on patchouli oil, because it is widely accepted that the important odour contributors are those found in the liquid fractions, in particular those having a Kovats Retention Index above 1500, and more particularly still, those containing predominately sesquiterpenoids, which would be analyzed by GC olfactometry on patchouli oil as such, and not a volatile fraction of patchouli oil, and particularly not its head space.

The Kovats Retention Index as it is known in the art is defined as the selective retention of perfume ingredients onto chromatographic columns based on the retention volume of the substance with respect to that to a homologous series of n-alkane standards.

The Kovats Retention Index can be experimentally derived using a DB-5 column according to techniques well known in the art, which do not need further elaboration here. In a particular embodiment, an Agilent Technologies 6890 gas chromatogram with Flame Ionization Detector (FID), or equivalent using a DB-5 (5% phenyl-methylpolysiloxane) column 30 m×0.25 mm i.d., with a 0.25 micron film thickness available from Agilent Technologies. Chromatographic conditions may be 1 mL/min of helium carrier with constant flow programming, a temperature program of 50° C. to 300° C. at 4° C. min., detector temperature 350° C., split injection at 300° C.

Different chromatographic conditions may be required to achieve separation of the analytes of interest and can be readily adjusted by one skilled in the art. A linear alkane hydrocarbon standard mix (C8-C22 available from Aldrich Chemical Company or equivalent) is injected and the retention time for each component is recorded. The test sample (appropriately diluted in a suitable solvent) is injected under the same conditions, and the retention time for each component of interest is recorded. The Kovats Index under non-isothermal conditions is calculated for each component of interest in the test sample using the equation:

KI=100n+100[(t_{substance}−tn)/(tₙ₊₁−tn)]

### Where:

t=the uncorrected retention time of a peak
substance=the peak of interest
n=the number of carbon atoms in the smaller alkane whose peak is adjacent to the peak of interest

In a particular embodiment of the invention compounds present in the fraction of patchouli oil, which may be present in a trapped head space, and having a Kovats Retention Index on a DB-5 column of 1500 or lower, more particularly 1450 or lower, still more particularly 1400 or lower, still more particularly 1350 or lower, and more particularly still 1300 or lower include, but are not limited to 2-ethyl furan, 4-Ethenyl-2-methoxyphenol, for example 4-VINYL GUAIACOL, ethyl 4-methylvalerate, (4S,4aS,8aR)-4,8a-Dimethyl-1,2,3,4,5,6,7,8-octahydronaphthalen-4a-ol, for example GEOSMIN, 4-Ethyl-2-methoxyphenol, for example 4-ETHYL GUAIACOL, 4-ethyl phenol, 2,6,6-trimethylcyclohexa-1,3-dienecarbaldehyde, for example SAFRANAL, 3-propyl phenol, iso-butyl methoxy pyrazine, 2-methoxy-3,6-dimethyl pyrazine and 1,2,7,7-tetramethylbicyclo[2.2.1]heptan-2-ol, for example 2-METHYL ISOBORNEOL (either of the enantiomers, or their mixtures in any proportion).

These compounds were not previously known to exist in patchouli oil, and many have odours that would not be readily associated with the characteristic patchouli odour. For example, ethyl 4-methylvalerate possesses a very attractive fruity odour that is not at all expected in patchouli. Furthermore, some of the compounds would not even be considered to be useful in perfumery, such as 2-methyl isoborneol (either of the enantiomers, or their mixtures in any proportion), which contributes the earthy odour in dirty water. Nevertheless, these compounds, alone or in combination can form a perfume complement that when added to patchouli extenders, can elevate the extenders and provide them with more authentic patchouli oil character.

Indeed, the use of 2-methyl isoborneol (either of the enantiomers, or their mixtures in any proportion) in perfumery is entirely unanticipated and forms another aspect of this invention.

In a more particular embodiment, the invention provides the use of 2-methyl isoborneol (either of the enantiomers, or their mixtures in any proportion) in a dilution of 0.1 to 1000 ppm in a fragrance composition.

Although the odour direction of the aforementioned ingredients are very useful as such, or in the context of augmenting patchouli extenders, given the fact that some of these compounds are not considered as conventional perfume ingredients, they may not be readily available on the perfumers' palette. Accordingly, in a perfume complement according to the invention, it may be particularly desirable to employ olfactively equivalent ingredients in a perfume complement, either additive with or as alternatives to, the ingredients found in the volatile fraction, which may be extracted from a head space, with a Kovats Retention Index of 1500 or less, recited above. Ingredients that the applicant found to be olfactive equivalents and which may be used in perfume complements either additively with or alternatively to the ingredients referred to above, include but are not limited to 2,6,6-trimethylcyclohexa-1,3-dienecarbaldehyde, for example SAFRANAL, 4,4,8a-trimethyldecahydronaphthalen-4a-ol, for example METHYL GEOSMIN, (3S,5R,8S)-5-Isopropenyl-3,8-dimethyl-3,4,5,6,7,8-hexahydro-1(2H)-azulenone, for example ROTUNDONE or, (3S,5R,8S)-5-Isopropenyl-3,8-dimethyl-3,4,5,6,7,8-hexahydro-1(2H)-azulenone, for example ROTUNDONE-containing materials (for example in the form of Akigalawood™), 2-isopropyl-3-methoxy pyrazine, or other olfactively similar pyrazine perfume ingredients, such as 2-methoxy-3,5 dimethyl pyrazine, 2-methoxy-5,6-dimethylpyrazine, 2-isopropyl-5-methoxy pyrazine, 2-isopropyl-6-methoxy pyrazine, 2-sec-butyl-3-methoxy pyrazine or 2-butyl-3-methoxy pyrazine; methyl geosmin, rotundone or rotundone-containing materials (for example in the form of Akigalawood®), clary sage oil, 3,8,8,11a-tetramethyldodecahydro-1H-3,5a-epoxynaphtho[2,1-c]oxepine, for example AMBERKETAL™, 2-(3,8-dimethyl-1,2,3,4,5,6,7,8-octahydroazulen-5-yl)propan-2-yl acetate, for example GUAIYL ACETATE, (E)-1-(2,6,6-trimethylcyclohexa-1,3-dien-1-yl)but-2-en-1-one, for example DAMASCENONE, 2-(2-(3,3,5-trimethylcyclohexyl)acetyl)cyclopentanone, for example DIONE, 4-ethyloctanoic acid, dimethyl sulphide, 2,4-diethoxy-5-methylpyrimidine, for example VETHYMINE™, iso-propyl-2-methyl-4-thiazole, pine oil (in particular Siberian pine oil), 2-(4-methylcyclohex-3-en-1-yl)propan-2-ol, for example 4-TERPINEOL, oct-1-en-3-ol, for example AMYL VINYL CARBINOL, 5-isopropyl-2-methylphenol, for example CARVACROL, 4-hydroxy-3-methoxybenzaldehyde, for example VANILLIN, 4-allyl-2-methoxyphenol, for example EUGENOL, 2-methoxyphenol, for example GUAIACOL, 2-methoxy-4-propylphenol, for example DIHYDRO EUGENOL, 3-hydroxy-4,5-dimethylfuran-2(5H)-one, for example CARAMEL LACTONE, 4-(1-ethoxyvinyl)-3,3,5,5-tetramethylcyclohexanone, for example KEPHALIS™, fenugreek absolute, immortelle absolute, cistus absolute, flouve absolute, beeswax absolute, (methyltrisulfanyl)methane, for example DIMETHYL TRISULFIDE, ethyl 2-methylpentanoate, for example MANZANATE™, 2-methyl propanoic acid, 3-methyl butyric acid, 4-methyl octanoic acid, (Z)-methyl 2-(3-oxo-2-(pent-2-en-1-yl)cyclopentyl)acetate, for example METHYL EPI JASMONATE,

In a more particular embodiment of the invention a perfume complement comprises:

at least one of the ingredients selected from

2-ethyl furan, 4-Ethenyl-2-methoxyphenol, for example 4-VINYL GUAIACOL, ethyl 4-methylvalerate, (4S,4aS,8aR)-4,8a-Dimethyl-1,2,3,4,5,6,7,8-octahydronaphthalen-4a-ol, for example GEOSMIN, 4-Ethenyl-2-methoxyphenol, for example 4-ETHYL GUAIACOL, 4-ethyl phenol, 2,6,6-trimethylcyclohexa-1,3-dienecarbaldehyde, for example SAFRANAL, 3-propyl phenol, iso-butyl methoxy pyrazine, 2-methoxy-3,6-dimethyl pyrazine and 1,2,7,7-tetramethylbicyclo[2.2.1]heptan-2-ol, for example 2-METHYL ISO BORNEOL, AND at least one of the ingredients selected from

2-isopropyl-3-methoxy pyrazine or other olfactively similar pyrazine perfume ingredients, such as 2-methoxy-3,5-dimethypyrazine, 2-methoxy-5,6-dimethylpyrazine, 2-isopropyl-5-methoxy pyrazine, 2-isopropyl-6-methoxy pyrazine, 2-sec-butyl-3-methoxy pyrazine or 2-butyl-3-methoxy pyrazine, 4,4,8a-trimethyldecahydronaphthalen-4a-ol, for example METHYL GEOSMIN, (3S,5R,8S)-5-Isopropenyl-3,8-dimethyl-3,4,5,6,7,8-hexahydro-1(2H)-azulenone, for example ROTUNDONE or ROTUNDONE-containing materials (for example in the form of Akigalawood®), clary sage, Amberketal, 3,8,8,11a-tetramethyldodecahydro-1H-3,5a-epoxynaphtho[2,1-c]oxepine, for example AMBERKETAL™, 2-(3,8-dimethyl-1,2,3,4,5,6,7,8-octahydroazulen-5-yl)propan-2-yl acetate, for example GUAIYL ACETATE, (E)-1-(2,6,6-trimethylcyclohexa-1,3-dien-1-yl)but-2-en-1-one, for example DAMASCENONE, 2-(2-(3,3,5-trimethylcyclohexyl)acetyl)cyclopentanone, for example DIONE, 4-ethyloctanoic acid, dimethyl sulphide, 2,4-diethoxy-5-methylpyrimidine, for example VETHYMINE™, iso-propyl-2-methyl-4-thiazole, pine oil (in particular Siberian pine oil), 2-(4-methylcyclohex-3-en-1-yl)propan-2-ol, for example 4-TERPINEOL, oct-1-en-3-ol, for example AMYL VINYL CARBINOL, 8a,9,9-Trimethyl-1,2,4a,5,6,7,8,8a-octahydro-1,6-methanonaphthalen-1-ol, for example NOR-PATCHOULENOL, 5-isopropyl-2-methylphenol, for example CARVACROL, 4-hydroxy-3-methoxybenzaldehyde, for example VANILLIN, 4-allyl-2-methoxyphenol, for example EUGENOL, 2-methoxyphenol, for example GUAIACOL, dihydro 4-allyl-2-methoxyphenol, for example EUGENOL, 3-hydroxy-4,5-dimethylfuran-2(5H)-one, for example CARAMEL LACTONE™ 4-(1-ethoxyvinyl)-3,3,5,5-tetramethylcyclohexanone, for example KEPHALIS™, fenugreek absolute, immortelle absolute, cistus absolute, flouve absolute, beeswax absolute, dimethyl trisulphide, ethyl 2-methylpentanoate, for example MANZANATE™, 2-methyl propanoic acid, 3-methyl butyric acid, 4-methyl octanoic acid and (Z)-methyl 2-(3-oxo-2-(pent-2-en-1-yl)cyclopentyl)acetate, for example METHYL EPI JASMONATE.

These so-called olfactive equivalent ingredients would not be considered to be conventional choices for a perfumer given the task of creating an accord with patchouli-like odour. A conventional bottom-up approach for the design of fragrances with patchouli-like odour would direct the perfumer to concentrate on selecting ingredients from the palette that were woody, heavy, substantive ingredients in the odour direction of the sesquiterpenoid fraction of patchouli oil. The discovery of the new fraction of ingredients in the head space provided the perfumer with new reference points from which to select somewhat more unconventional perfumery ingredients.

The perfume complements described herein above may be further complemented with the addition of one or more ingredients selected from the group consisting of 8-(sec-butyl)-5,6,7,8-tetrahydroquinoline, for example BIGARYL™, carrot seed oil, tea tree oil, 2,3-dimethyl pyrazine, 2,5-dimethyl pyrazine, coffee extract, 5,8a-dimethyl-1,3,4,7,8,8a-hexahydronaphthalen-4a(2H)-ol, for example GEOVERTOL™, (E)-4-methyldec-3-en-5-ol, for example UNDECAVERTOL™, methyl 2,4-dihydroxy-3,6-dimethylbenzoate, for example EVERNYL, 2-(3-phenylpropyl)pyridine, for example CORPS RACINE™, cistus oil, hydrocarboresine, suederal or other similar leather accords, 1a,3,3,4,6,6-hexamethyl-1a,2,3,4,5,6,7,7a-octahydronaphtho[2,3-b]oxirene, for example MOXALONE™, 2-isobutylquinoline, for example ISOBUTYL QUINOLINE, 2,3,3-trimethyl-2,3-dihydro-1H-inden-1-one, for example SAFRALEINE, birch tar, cade oil, styrax pyrogenated, 2-methoxy-4-methylphenol, for example CREOSOL, cypriol oil, 3-hydroxy-2-methyl-4H-pyran-4-one, for example MALTOL, 2-ethyl-4-hydroxy-5-methylfuran-3(2H)-one, for example HOMOFURONOL, 2-hydroxy-3-methylcyclopent-2-enone, for example CORYLONE, 2-(4-Methyl-1,3-thiazol-5-yl)ethanol, for example SULPHUROL™, 2-hydroxy-3,4-dimethyl-2-cyclopenten-1-one, for example METHYL CORYLONE, 4-allyl-2-methoxyphenyl acetate, for example EUGENYL ACETATE, (E)-2-methoxy-4-(prop-1-en-1-yl)phenol, for example EUGENOL, 2-ethoxy-4-methylphenol, for example ULTRAVANIL™, (1R,4R,6R,10S)-4,12,12-Trimethyl-9-methylen-5-oxatricyclo[8.2.0.04,6]dodecan, for example CARYOPHYLLENE OXIDE, 1,3,4,5,6,7-hexahydro-.beta.,1,1,5,5-pentamethyl-2H-2,4a-Methanonaphthalene-8-ethanol, for example AMBERMAX™, (4aR,5R,7aS,9R)-Octahydro-2,2,5,8,8,9a-hexamethyl-4H-4a,9-methanoazuleno[5,6-d]-1,3-dioxole, for example AMBROCENIDE™, 1-(2-tert-butylcyclohexyl)oxybutan-2-ol, for example AMBER XTREM™, tobacco absolute, hay absolute, bran absolute, 4-Methylpentanoic acid, for example 4-methyl valeric acid, isoamyl alcohol, hexanal, hexanol, (Z)-hex-3-en-1-yl acetate, for example HEXENYL-3-CIS ACETATE, 2,6,6-trimethylbicyclo[3.1.1]hept-2-ene, for example PINENE ALPHA, 6,6-dimethyl-2-methylenebicyclo[3.1.1]heptane, for example PINENE BETA, 4-methylene-1-(1-methylethyl)bicyclo[3.1.0]hexane, for example SABINENE, 7-methyl-3-methyleneocta-1,6-diene, for example MYRCENE, non-2-enal, 8a,9,9-Trimethyl-1,2,4a,5,6,7,8,8a-octahydro-1,6-methanonaphthalen-1-ol, for example NOR-PATCHOULENOL, cis 3-hexanol, 5-methyl-2-hexanone, for example METHYL ISOAMYL KETONE, 2-methyl butyric acid, indole, 3-methyl-1H-indole, for example SKATOLE, p-cresol, p-cresyl acetate, costus oliffac oil, 6-methyl-5-hepten-2-one, 2,6,6-Trimethyl-1-cyclohexene-1-carbaldehyde, for example BETA CYCLOCITRAL, (E)-4-(2,6,6-trimethylcyclohex-1-en-1-yl)but-3-en-2-one, for example IONONE BETA, undecan-2-one and nonan-2-one.

Where trivial names are used to describe useful perfume ingredients hereinabove, the skilled perfumer would understand that these are commonly used names by perfumers. However, the skilled perfumer would also understand that these ingredients may also be known by other trivial synonyms, by CAS registry numbers, or by more formal nomenclature, such as IUPAC nomenclature. Furthermore, the skilled perfumer will be familiar with these other trivial synonyms, as well as with more formal nomenclature, or at the least, will be aware of standard reference works, such as The Good Scents Company website, or the Leffingwell website, which contains a comprehensive list of trivial names, registry numbers and more formal nomenclature for the perfume ingredients contained on the perfumer's palette.

In particular embodiments of the invention, perfume complements comprising more particular combinations of the abovementioned compounds are also provided. Better to define these combinations, the compounds hereinabove named may be divided into Groups A, B, C, D and E, as follows:

Group A—
(i) 2-methoxy-3,6-dimethypyrazine,
(ii) 2-isopropyl-3-methoxy pyrazine, 2-isobutyl-3-methoxy pyrazine,
(iii) 2,4-diethoxy-5-methylpyrimidine, for example VETHYMINE™, iso-propyl-2-methyl-4-thiazole, Siberian pine oil, 2-(4-methylcyclohex-3-en-1-yl)propan-2-ol, for example 4-TERPINEOL, 2-methoxy-3,5-dimethypyrazine, 2-methoxy-5,6-dimethylpyrazine, 2-isopropyl-5-methoxy pyrazine, 2-isopropyl-6-methoxy pyrazine, 2-sec-butyl-3-methoxy pyrazine and 2-butyl-3-methoxy pyrazine,
(iv) 8-(sec-butyl)-5,6,7,8-tetrahydroquinoline, for example BIGARYL™, carrot seed oil, tea tree oil, 2,3-dimethyl pyrazine, 2,5-dimethyl pyrazine, a black chocolate accord or a coffee oil obtained by supercritical carbon dioxide extraction.

Group B—
(i) 2-methyl 1,2,7,7-tetramethylbicyclo[2.2.1]heptan-2-ol, for example 2-METHYL ISOBORNEOL (either of the enantiomers, or their mixtures in any proportion),
(ii) 4,4,8a-trimethyldecahydronaphthalen-4a-ol, for example METHYL GEOSMIN,
(iii) (4S,4aS,8aR)-4,8a-Dimethyl-1,2,3,4,5,6,7,8-octahydronaphthalen-4a-ol, for example GEOSMIN, oct-1-en-3-ol (oct-1-en-3-ol, for example AMYL VINYL CARBINOL), 2-methyl 1,2,7,7-tetramethylbicyclo[2.2.1]heptan-2-ol, for example 2-METHYL ISO BORNEOL, and 8a,9,9-Trimethyl-1,2,4a,5,6,7,8,8a-octahydro-1,6-methanonaphthalen-1-ol, for example NOR-PATCHOULENOL,
(iv) 5,8a-dimethyl-1,3,4,7,8,8a-hexahydronaphthalen-4a(2H)-ol, for example GEOVERTOL, (E)-4-methyldec-3-en-5-ol, for example UNDECAVERTOL™, methyl 2,4-dihydroxy-3,6-dimethylbenzoate, for example EVERNYL and 2-(3-phenylpropyl)pyridine, for example CORPS RACINE™

Group C—
(i) 3-propyl phenol,
(ii) 4-ethyl phenol,
(iii) 4-Ethenyl-2-methoxyphenol, for example 4-VINYL GUAIACOL, 2,6,6-trimethylcyclohexa-1,3-dienecarbaldehyde, for example SAFRANAL, 4-vinyl phenol, 4-Ethyl-2-methoxyphenol, for example 4-ETHYL GUAIACOL, 5-isopropyl-2-methylphenol, for example CARVACROL, 4-propyl phenol and 3-ethyl phenol,
(iv) Cistus oil, hydrocarboresine, suederal or leather accord), 1a,3,3,4,6,6-hexamethyl-1a,2,3,4,5,6,7,7a-octahydronaphtho[2,3-b]oxirene, for example MOXALONE™, 2-isobutylquinoline, for example ISOBUTYL QUINOLINE, 2,3,3-trimethyl-2,3-dihydro-1H-inden-1-one, for example SAFRALEINE, birch tar, cade oil, styrax pyrogenated and 2-methoxy-4-methylphenol, for example CREOSOL,

Group D—
(i) (3S,5R,8S)-5-Isopropenyl-3,8-dimethyl-3,4,5,6,7,8-hexahydro-1(2H)-azulenone, for example ROTUNDONE (for example in the form of Akigalawood™), clary sage absolute, 3,8,8,11a-tetramethyldodecahydro-1H-3,5a-epoxynaphtho[2,1-c]oxepine, for example AMBERKETAL™,
(ii) 2-(3,8-dimethyl-1,2,3,4,5,6,7,8-octahydroazulen-5-yl)propan-2-yl acetate, for example GUAIYL ACETATE, (E)-1-(2,6,6-trimethylcyclohexa-1,3-dien-1-yl)but-2-en-1-one, for example DAMASCENONE (Firm), 2-(2-(3,3,5-trimethylcyclohexyl)acetyl)cyclopentanone, for example DIONE,
(iii) 4-hydroxy-3-methoxybenzaldehyde, for example VANILLIN, 4-allyl-2-methoxyphenol, for example EUGENOL, 2-methoxyphenol, for example GUAIACOL, dihydro 4-allyl-2-methoxyphenol, for example EUGENOL, 3-hydroxy-4,5-dimethylfuran-2(5H)-one, for example CARAMEL LACTONE™, (Giv), 4-(1-ethoxyvinyl)-3,3,5,5-tetramethylcyclohexanone, for example KEPHALIS, fenugreek absolute, immortelle absolute, cistus absolute flouve absolute and beeswax absolute,
(iv) Cypriol oil, 3-hydroxy-2-methyl-4H-pyran-4-one, for example MALTOL, 2-ethyl-4-hydroxy-5-methylfuran-3(2H)-one, for example HOMOFURONOL, 2-hydroxy-3-methylcyclopent-2-enone, for example CORYLONE, 2-(4-Methyl-1,3-thiazol-5-yl)ethanoL, for example SULPHUROL™ 2-hydroxy-3,4-dimethyl-2-cyclopenten-1-one, for example METHYL CORYLONE, 4-allyl-2-methoxyphenyl acetate, for example EUGENYL ACETATE, iso-4-allyl-2-methoxyphenol, for example EUGENOL, 2-ethoxy-4-methylphenol, for example ULTRAVANIL™, (1R,4R,6R,10S)-4,12,12-Trimethyl-9-methylen-5-oxatricyclo[8.2.0.04,6]dodecan, for example CARYOPHYLLENE OXIDE, 1,3,4,5,6,7-hexahydro-.beta.,1,1,5,5-pentamethyl-2H-2,4a-Methanonaphthalene-8-ethanol, for example AMBERMAX™, (4aR,5R,7aS,9R)-Octahydro-2,2,5,8,8,9a-hexamethyl-4H-4a,9-methanoazuleno[5,6-d]-1,3-dioxole, for example AMBROCENIDE™, 1-(2-tert-butylcyclohexyl)oxybutan-2-ol, for example AMBER XTREM™ (IFF), osmanthus accord, tobacco absolute, hay absolute and bran absolute,

Group E—
(i) 4-ethyloctanoic acid, dimethyl disulphide,
(ii) ethyl 4-methylvalerate, dimethyl trisulphide,
(iii) ethyl 2-methylpentanoate, for example MANZANATE™, 2-methylpropanoic acid (iso butyric), 3-methyl butyric acid, 4-methyloctanoic acid and (Z)-methyl 2-(3-oxo-2-(pent-2-en-1-yl)cyclopentyl)acetate, for example METHYL EPI JASMONATE,
(iv) 4-methylvaleric acid, isoamyl alcohol, hexanal, hexanol, cis-3-hexenyl acetate, alpha-pinene, beta-pinene, 4-methylene-1-(1-methylethyl)bicyclo[3.1.0]hexane, for example SABINENE, 7-methyl-3-methyleneocta-1,6-diene, for example MYRCENE, non-2-enal, cis 3-hexenol, 5-methyl-2-hexanone, for example METHYL ISOAMYL KETONE, 2-methyl butyric acid, Castoreum base, indole, 3-methyl-1H-indole, for example SKATOLE p-cresol, p-cresyl acetate, costus oliffac 6-methyl-5-hepten-2-one, 2,6,6-Trimethyl-1-cyclohexene-1-carbaldehyde, for example BETA CYCLOCITRAL, (E)-4-(2,6,6-trimethylcyclohex-1-en-1-yl)but-3-en-2-one, for example IONONE BETA, undecan-2-one and nonan-2-one

In a particular embodiment, the compounds may be combined to provide perfume complements in any one of the following combinations:
(i) At least one from Group A through E,
(ii) At least one each from Group A through E,
(iii) At least one of A(i), B(i), C(i), D(i) and E(i),
(iv) At least one of A(ii), B(ii), C(ii), D(ii) and E(ii).

In a further particular embodiment, the compounds may be combined to provide perfume complements that comprise either or both of the following:
(i) All of A(i), B(i), C(i), D(i) and E(i),
(ii) All of A(ii), B(ii), C(ii), D(ii) and E(ii).

In a further particular embodiment, the compounds may be combined to provide perfume complements that comprise all of A(i), B(i), C(i), D(i) and E(i) and all of A(ii), B(ii), C(ii), D(ii) and E(ii).

In a further particular embodiment, the compounds may be combined to provide perfume complements that comprise all of A(i), B(i), C(i), D(i) and E(i), all of A(ii), B(ii), C(ii), D(ii) and E(ii) and at least one compound selected from any one of Groups A(iii), B(iii), C(iii), D(iii) and E(iii).

In a further particular embodiment, the compounds may be combined to provide perfume complements that comprise all of A(i), B(i), C(i), D(i) and E(i), all of A(ii), B(ii), C(ii), D(ii) and E(ii) and at least one compound selected from each of Groups A(iii), B(iii), C(iii), D(iii) and E(iii).

In a further particular embodiment, the compounds may be combined to provide perfume complements that comprise all of A(i), B(i), C(i), D(i) and E(i), all of A(ii), B(ii), C(ii), D(ii) and E(ii) and all of Groups A(iii), B(iii), C(iii), D(iii) and E(iii).

In a further particular embodiment, the compounds may be combined to provide perfume complements that comprise all of A(i), B(i), C(i), D(i) and E(i), all of A(ii), B(ii), C(ii), D(ii) and E(ii) and at least one compound selected from any one of Groups A(iv), B(iv), C(iv), D(iv) and E(iv).

In a further particular embodiment, the compounds may be combined to provide perfume complements that comprise all of A(i), B(i), C(i), D(i) and E(i), all of A(ii), B(ii), C(ii), D(ii) and E(ii) and at least one compound selected from each of Groups A(iv), B(iv), C(iv), D(iv) and E(iv).

In a further particular embodiment, the compounds may be combined to provide perfume complements that comprise all of A(i), B(i), C(i), D(i) and E(i), all of A(ii), B(ii), C(ii), D(ii) and E(ii) and all of Groups A(iv), B(iv), C(iv), D(iv) and E(iv).

In a further particular embodiment, the compounds may be combined to provide perfume complements that comprise all of A(i), B(i), C(i), D(i) and E(i), all of A(ii), B(ii), C(ii), D(ii) and E(ii) and at least one compound selected from each of Groups A(iii), B(iii), C(iii), D(iii) and E(iii) and A(iv), B(iv), C(iv), D(iv) and E(iv).

The perfume complements described herein above may be used as such to perfume all manner of fragrance formulations useful in fine or technical perfumery. However, the perfume complements are particularly useful when they are added to a patchouli extender in order to bring the odour of the extender closer to that of patchouli oil.

The manner in which the perfume complement is added to a fragrance formulation, and in particular a patchouli extender, is not particularly critical. Thus, when a perfume complement comprises more than one compound, the compounds may be added to a fragrance formulation, and in particular a patchouli extender, singularly or in any combination.

Accordingly, in another aspect of the invention there is provided a method of adapting, modifying or improving the odour of a fragrance formulation, and in particular a patchouli extender, said method comprising the step of adding to the formulation a perfume complement described herein above.

In a more particular embodiment, in a method of adapting, modifying or improving the odour of a fragrance formulation, and in particular a patchouli extender, the ingredients of the perfume complement are added sequentially, separately or simultaneously to the fragrance formulation.

The invention also provides a method of preparing a fragrance formulation, comprising the step of adding to a fragrance formulation a perfume complement as herein above defined.

In a more particular embodiment, in a method of preparing a fragrance formulation, the ingredients of the perfume complement are added sequentially, separately or simultaneously to a fragrance formulation.

The use of the abovementioned perfume complements in combination with patchouli extenders, enables the preparation of extenders or oils that more closely resemble patchouli oil, and that can in many instances, substitute for the patchouli oil itself.

As hereinabove mentioned, there are a number of commercially-available patchouli extenders. In addition to the previously-mentioned Clearwood™ (ex Firmenich), other examples include Patchouli Reco 3 (ex Charabot), Patchouli Extender (ex Ventós), Patchouli Extender (ex Indukern) and Patchouli 2235, 4184 and DM 0356 (ex Robertet).

In a particular embodiment of the invention, the patchouli extender is the product of advanced fermentation.

In a more particular embodiment, the patchouli extender is formed by the action of a sesquiterpene synthase on a suitable terpene precursor substrate. An example of a suitable terpene precursor substrate is farnesyl pyrophosphate (FPP). Sesquiterpene synthases, methods of their production, as well as their use in the preparation of mixtures of terpenes, including a patchouli extender, are disclosed in WO 2005/052163, which is incorporated herein by reference.

In yet another aspect of the present invention, there is also provided fragrance formulation comprising a patchouli extender, and a perfume complement as hereinabove defined.

The levels at which the compound or compounds used in perfume complements may be employed in a fragrance formulation, and in particular a patchouli extender, will depend on a variety of factors, including the olfactory nature of the extender or formulation and the olfactory effect desired. Thus, the levels of individual compounds will vary across a wide range, from as low as 0.01 ppm or as high as 10% by weight based on the total weight of the extender or fragrance formulation into which they are incorporated.

Particular perfume complements and ranges include:

At least one of A(i), A(ii), B(i), B(ii), C(i), C(ii), D(i), D(ii), E(i) and E(ii), each present in the proportion 0.1 ppm-100000 ppm (0.00001 to 10 weight percent), more particularly 0.1 ppm-1000 ppm (0.00001 to 0.1 weight percent), of the patchouli extender or fragrance formulation. At least one of A(i), A(ii), B(i), B(ii), C(i), and C(ii), each present in the range 0.01 ppm-100 ppm (0.000001 to 0.01 weight percent) of the patchouli extender or fragrance formulation.

At least one compound from Groups A(i), A(ii), B(i), B(ii), C(i), C(ii), and E(i) is present in the proportion 0.1 ppm-100 ppm, and at least one compound from Groups D(i), D(ii), D(iii), D(iv) is present in the proportion 1000 ppm-100000 ppm (0.1%-10% weight percent) of the patchouli extender or fragrance formulation.

At least one compound from Groups A(i), A(ii), B(i), B(ii), C(i), C(ii), and E(i) present in the proportion 1 ppm-100 ppm, and at least compound from group D(i) present in the proportion 1000 ppm-100000 ppm (0.1%-10% weight percent),

AND any of the foregoing complements, wherein

one or more from groups (iii) and (iv) are present from 0.1 ppm-10000 ppm (0.00001%-1% weight percent), of the patchouli extender or fragrance formulation.

Fragrance formulations, in addition to the perfume complement defined herein above, may contain additional perfumery ingredients, carriers and adjuvants commonly used in fine perfumery and technical perfumery.

Many of these additional perfumery and non-perfumery ingredients are disclosed in reference texts such as the book by S. Arctander, Perfume and Flavor Chemicals, 1969, Montclair, N.J., USA, or its more recent versions, or in other works of a similar nature, such as thegoodscentcompany.com and Leffingwell websites, as well as in the abundant patent literature in the field of perfumery. It is also understood that said additional ingredients may also be compounds known to release in a controlled manner various types of perfuming compounds, such as perfume precursors that are themselves not recognized as perfume ingredients, but which can degrade under the influence of an external stimulus such as light or heat or chemical interaction to release a perfumery ingredient.

Additional perfumery ingredients include the following non-limiting examples:
essential oils and extracts, e.g. castoreum, costus root oil, oak moss absolute, geranium oil, tree moss absolute, basil oil, fruit oils such as bergamot oil and mandarine oil, myrtle oil, palmarose oil, patchouli oil, petitgrain oil, jasmine oil, rose oil, sandalwood oil, wormwood oil, lavender oil or ylang-ylang oil,
alcohols, e.g. cinnamic alcohol, citronellol, 3-methyl-5-(2,2,3-trimethyl-3-cyclopenten-1-yl)-4-penten-2-ol), for example EBANOL™-farnesol, geraniol, 6-ethyl-3-methyl-5(6)-octen-1-ol, for example SUPER MUGUET™, linalool, menthol, nerol, phenylethyl alcohol, rhodinol, 5-(2,2,3-trimethyl-3-cyclopentyl)-3-methylpentan-2-ol, for example SANDALORE™- or 1-(2,2,6-trimethylcyclohexyl)hexan-3-ol, for example TIMBEROL™
aldehydes and ketones, e.g. 7-(3-methylbutyl)-1,5-benzodioxepin-3-one, for example AZURONE™, anisaldehyde, 0-amylcinnamaldehyde, 2-acetyl-1,2,3,4,5,6,7,8-octahydro-1,2,8,8-tetramethylnaphthalene, for example GEORGYWOOD™, hydroxycitronellal, 1-(2,3,8,8-tetramethyl-1,2,3,4,5,6,7,8-octahydronaphthalen-2-yl)ethanone, for example ISO E SUPER™ (E)-3-methyl cedryl ketone, methylionone, verbenone or; -4-(2,6,6-trimethylcyclohex-2-en-1-yl)but-3-en-2-one, for example ISORALDEINE™-3-(4-(tert-butyl)phenyl)-2-methylpropanal, for example LILIAL™-1-((1S,8aS)-1,4,4,6-tetramethyl-2,3,3a,4,5,8-hexahydro-1H-5,8a-methanoazulen-7-yl)ethanone, for example METHYL CEDRYL KETONE, 1-(2,6,6-trimethyl-1-cyclohex-2-enyl)pent-1-en-3-one, for example ALPHA METHYL IONONE, 4,6,6-trimethylbicyclo[3.1.1]hept-3-en-2-one, for example VERBENONE or
ethers and acetals, e.g. 3a,6,6,9a-tetramethyl-2,4,5,5a,7,8,9,9b-octahydro-1H-benzo[e][1]benzofuran, for example AMBROX;™, geranyl methyl ether, 4-methyl-2-(2-methylprop-1-en-1-yl)tetrahydro-2H-pyran, for example ROSE OXIDE or ((1R,3S,6S)-rel-2′,2′,3,7,7-pentamethyl-spiro[bicyclo[4.1.0]heptane-2,5′-[1,3]dioxane], for example SPIRAMBRENE™),
   esters and lactones, e.g. benzyl acetate, (1S,6R,8aR)-1,4,4,6-tetramethyloctahydro-1H-5,8a-methanoazulen-6-yl acetate, for example CEDRYL ACETATE, decalactone, 2-(1-(3,3-dimethylcyclohexyl)ethoxy)-2-methylpropyl propionate, for example HELVETOLIDE™ undecalactone or (4,8-dimethyl-2-propan-2-ylidene-3,3a,4,5,6,8a-hexahydro-1H-azulen-6-yl) acetate, for example VETIVERYL ACETATE,
   macrocycles, e.g. (Z)-oxacycloheptadec-10-en-2-one, for example AMBRETTOLIDE, 1,4-dioxacycloheptadecane-5,17-dione, for example ETHYLENE BRASSYLATE or 16-oxacyclohexadecan-1-one, for example EXALTOLIDE™,

The fragrance formulations may also comprise standard perfumery adjuvants. Adjuvants are ingredients that do not influence the olfactive properties of a fragrance formulation, but which can affect its quality in other ways. Adjuvants may include colourants, pH buffers, preservatives, anti-oxidants, and the like. Adjuvants may also include solvents or diluents and emulsifiers, Suitable solvents include dipropylene glycol (DPG), isopropyl myristate (IPM), triethyl citrate (TEC), alcohol (e.g. ethanol), propylene glycol (PG), triacetin, diethyl phthalate (DEP) and benzyl alcohol.

Perfume complements as hereinabove described may be used in a broad range of fragrance applications, e.g. in any field of fine and functional perfumery, such as perfumes, air care products, household products, laundry products, body care products and cosmetics. The complements can be employed in widely varying amounts, depending upon the specific application and on the nature and quantity of other odorant ingredients. The proportion is typically from 0.001 to 20 weight percent of the consumer product.

In one embodiment, perfume complements of the present invention may be employed in a fabric softener in an amount of from 0.01 to 5 weight percent.

In another embodiment, perfume complements of the present invention may be used in fine perfumery in amounts from 0.005 to 10 weight percent (e.g. up to about 2 weight percent), more preferably between 0.01 and 5 weight percent.

However, these values are given only by way of example, since the experienced perfumer may also achieve effects or may create novel accords with lower or higher concentrations.

The perfume complements as hereinabove described may be employed in a consumer product simply by directly mixing the composition with the consumer product base (i.e. the consumer product formulation, less the perfumery component. The base will typically include surfactants, diluents and solvents, bleaches, optical brighteners and fluorescent agents, fillers and extenders, pigments, dyestuffs and other colouring matters, abrasive materials, detergent builders, thickeners and rheology modifiers, used in art recognised proportions).

Alternatively, they may be first entrapped with an entrapment material, for example, polymers, capsules, microcapsules and nanocapsules, liposomes, film formers, absorbents such as carbon or zeolites, cyclic oligosaccharides and mixtures thereof. They may be dissolved or dispersed in a carrier material, such as a fat, or enrobed with maltose-dextrin, gelatine, gum Arabic and the like.

Thus, the disclosure additionally provides a method of manufacturing a consumer product, comprising the incorporation of a perfume complement as hereinabove described by admixing the perfume complement to a consumer product base.

The disclosure additionally provides a method for improving, enhancing or modifying a consumer product by means of the addition thereto of an organoleptically appropriate amount of a perfume complement as hereinabove described.

The consumer product in which the perfume complements may be used may be any such product in which the odour of the perfume complements is desired. Non-limiting examples include fine perfumery, e.g. perfume and eau de toilette, fabric care, household products and personal care products such as laundry care detergents, rinse conditioner, personal cleansing composition, detergent for dishwasher, surface cleaner, laundry products, e.g. softener, bleach, detergent, body-care products, e.g. shampoo, shower gel, air care products and cosmetics, e.g. deodorant, vanishing cream.

The disclosure is further described with reference to the following non-limiting example, which depicts a specific embodiment.

### EXAMPLE

To a sample of Clearwood™ patchouli extender (ex Firmenich) was added 10% by weight of a mixture of the following materials (the mixture is referred to as “Formula A”):

| Formula A | % (wt) |
|---|---|
| Clary sage abs @ 1% in DEP | 34 |
| Cistus abs @ 1% in DEP | 20 |
| AKIGALAWOOD ™ | 10 |
| 2-methoxyphenol, for example GUAIACOL @ 0.1% | 10 |
| in DPG | |
| 4-ethyloctanoic acid @ 0.1% in DPG | 6 |
| 2-methyl 1,2,7,7-tetramethylbicyclo[2.2.1]heptan-2- | 6 |
| ol, for example 2-METHYL ISOBORNEOL @ 1% | |
| in DPG | |
| 2,4-diethoxy-5-methylpyrimidine, for example | 3 |
| VETHYMINE ™ @ 0.01% in DPG | |
| 2-isopropyl-3-methoxy pyrazine @ 0.01% in DPG | 2 |
| iso butyric acid @ 0.1% in DPG | 2 |
| cistus oil @ 10% in DEP | 2 |
| 4-(1-ethoxyyinyl)-3,3,5,5-tetramethylcyclohexanone, | 2 |
| for example KEPHALIS ™ | |
| METHYL GEOSMIN @ 1% in DPG | 2 |
| 3-propyl phenol @ 0.1% in DPG | 1 |
| Total | 100 |

The treated Clearwood™, along with an untreated sample and a sample of patchouli oil were submitted unidentified to a panel oftrained perfumers, who were asked to assess the odour characteristics of the three samples in the following applications:
Alcoholic solution (5%) on blotter
Added to shampoo base at 0.2%
Added to fabric conditioner base at 0.2% subsequently used to wash cloth, which was then dried

The findings are shown in the following table.

| | |
|---|---|
| Application | Perfumer comments |

5% in Alcoholic solution on blotter

| | |
|---|---|
| Clearwood ™ | weak, woody. |
| Clearwood ™ + Formula A | adds earthy and pyrazine |
| | character of patchouli |
| Patchouli oil | Typical patchouli, soft |
| | woody, earthy. |

0.2% In shampoo base

| | |
|---|---|
| Clearwood ™ | weak |
| Clearwood ™ + Formula A | stronger, earthy, smoky |
| | effect |
| Patchouli oil | Strong, powdery effect. |

0.2% in Fabric Conditioner base. Washed and dried cloth.

| | |
|---|---|
| Clearwood ™ | Weak woody |
| Clearwood ™ + Formula A | more performing, more |
| | patchouli like. |
| Patchouli oil | Strong, musty, earthy, |
| | medicinal effect. |

1. A perfume complement comprising one or more compounds selected from compounds present in the fraction of patchouli oil having a Kovats Retention Index on a DB-5 column of 1500 or lower and/or olfactively equivalent perfume ingredients.

2. A perfume complement according to claim 1, wherein the compounds have a Kovats Retention Index on a DB-5 GC column of 1300 or lower, and/or olfactively equivalent perfume ingredients.

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. A perfume complement according to claim 1 comprising one or more compounds selected from the group consisting of:
2-methoxy-3,6-dimethyl pyrazine, iso-butyl methoxy pyrazine, 2-isopropyl-3-methoxy pyrazine, 2-methyl iso-borneol (either of the enantiomers, or their mixtures in any proportion), 4,4,8a-trimethyldecahydronaphthalen-4a-ol, for example METHYL GEOSMIN, 4-ethyloctanoic acid, 3-propyl phenol, (3S,5R,8S)-5-Isopropenyl-3,8-dimethyl-3,4,5,6,7,8-hexahydro-1(2H)-azulenone, for example ROTUNDONE or (3S,5R,8S)-5-Isopropenyl-3,8-dimethyl-3,4,5,6,7,8-hexahydro-1(2H)-azulenone, for example ROTUNDONE-containing materials (for example in the form of AKIGALAWOOD™), 3,8,8,11a-tetramethyldodecahydro-1H-3,5a-epoxynaphtho[2,1-c]oxepine, for example AMBERKETAL™, 2-(2-(3,3,5-trimethylcyclohexyl)acetyl)cyclopentanone, for example DIONE, and 2-(3,8-dimethyl-1,2,3,4,5,6,7,8-octahydroazulen-5-yl)propan-2-yl acetate, for example GUAIYL ACETATE.

24. A perfume complement according to claim 1 comprising one or more compounds selected from the group consisting of:
2-ethyl furan, 4-Ethenyl-2-methoxyphenol, for example 4-VINYL GUAIACOL, ethyl 4-methylvalerate (4S,4aS,8aR)-4,8a-Dimethyl-1,2,3,4,5,6,7,8-octahydronaphthalen-4a-ol, for example GEOSMIN, 4-Ethenyl-2-methoxyphenol, for example 4-ETHYL GUAIACOL, 4-ethyl phenol, 2,6,6-trimethylcyclohexa-1,3-dienecarbaldehyde, for example SAFRANAL, 3-propyl phenol, iso-butyl methoxy pyrazine, 2-methoxy-3,6-dimethyl pyrazine and 2-methyl iso-borneol (either of the enantiomers, or their mixtures in any proportion).

25. A perfume complement according to claim 1 comprising one or more of the compounds selected from the group consisting of:
2-isopropyl-3-methoxy pyrazine, or other olfactively similar pyrazine perfume ingredients, such as 2-methoxy-3,5-dimethypyrazine, 2-methoxy-5,6-dimethylpyrazine, 2-isopropyl-5-methoxy pyrazine, 2-isopropyl-6-methoxy pyrazine, 2-sec-butyl-3-methoxy pyrazine or 2-butyl-3-methoxy pyrazine, 4,4,8a-trimethyldecahydronaphthalen-4a-ol, for example METHYL GEOSMIN, (3S,5R,8S)-5-Isopropenyl-3,8-dimethyl-3,4,5,6,7,8-hexahydro-1(2H)-azulenone, for example ROTUNDONE or (3S,5R,8S)-5-Isopropenyl-3,8-dimethyl-3,4,5,6,7,8-hexahydro-1(2H)-azulenone, for example ROTUNDONE-containing materials (for example in the form of AKIGALAWOOD™), clary sage, 3,8,8,11a-tetramethyldodecahydro-1H-3,5a-epoxynaphtho[2,1-c]oxepine, for example AMBERKETAL™, 2-(3,8-dimethyl-1,2,3,4,5,6,7,8-octahydroazulen-5-yl)propan-2-yl acetate, for example GUAIYL ACETATE, (E)-1-(2,6,6-trimethylcyclohexa-1,3-dien-1-yl)but-2-en-1-one, for example DAMASCENONE, 2-(2-(3,3,5-trimethylcyclohexyl)acetyl)cyclopentanone, for example DIONE, 4-ethyloctanoic acid, dimethyl sulphide, 2,4-diethoxy-5-methylpyrimidine, for example VETHYMINE™, iso-propyl-2-methyl-4-thiazole, pine oil (in particular Siberian pine oil), 2-(4-methylcyclohex-3-en-1-yl)propan-2-ol, for example 4-TERPINEOL, oct-1-en-3-ol, for example AMYL VINYL CARBINOL, 5-isopropyl-2-methylphenol, for example CARVACROL, 4-hydroxy-3-methoxybenzaldehyde, for example VANILLIN, 4-allyl-2-methoxyphenol, for example EUGENOL, 2-methoxyphenol, for example GUAIACOL, dihydro 4-allyl-2-methoxyphenol, for example EUGENOL, 3-hydroxy-4,5-dimethylfuran-2(5H)-one, for example CARAMEL LACTONE, 4-(1-ethoxyvinyl)-3,3,5,5-tetramethylcyclohexanone, for example KEPHALIS™, fenugreek absolute, immortelle absolute, cistus absolute, flouve absolute, beeswax absolute, dimethyl trisulphide, manzanate, 2-methyl propanoic acid, 3-methyl butyric acid, 4-methyl octanoic acid and (Z)-methyl 2-(3-oxo-2-(pent-2-en-1-yl)cyclopentyl)acetate, for example METHYL EPI JASMONATE.

26. A perfume complement according to claim 1 comprising
at least one first ingredient selected from: 2-ethyl furan, 4-Ethenyl-2-methoxyphenol, for example 4-VINYL GUAIACOL, ethyl 4-methylvalerate, (4S,4aS,8aR)-4,8a-Dimethyl-1,2,3,4,5,6,7,8-octahydronaphthalen-4a-ol, for example GEOSMIN, 4-Ethenyl-2-methoxyphenol, for example 4-ETHYL GUAIACOL, 4-ethyl phenol, 2,6,6-trimethylcyclohexa-1,3-dienecarbaldehyde, for example SAFRANAL, 3-propyl phenol, iso-butyl methoxy pyrazine, 2-methoxy-3,6-dimethyl pyrazine and 2-methyl isoborneol; 1,2,7,7-tetramethylbicyclo[2.2.1]heptan-2-ol, for example 2-METHYL ISOBORNEOL; at least one second ingredient selected from: 2-isopropyl-3-methoxy pyrazine, or other olfactively similar pyrazine perfume ingredients, such as 2-methoxy-3,5-dimethypyrazine, 2-methoxy-5,6-dimethylpyrazine, 2-isopropyl-5-methoxy pyrazine, 2-isopropyl-6-methoxy pyrazine, 2-sec-butyl-3-methoxy pyrazine or 2-butyl-3-methoxy pyrazine, 4,4,8a-trimethyldecahydronaphthalen-4a-ol, for example METHYL GEOSMIN, (3S,5R,8S)-5-Isopropenyl-3,8-dimethyl-3,4,5,6,7,8-hexahydro-1(2H)-azulenone, for example ROTUNDONE or (3S,5R,8S)-5-Isopropenyl-3,8-dimethyl-3,4,5,6,7,8-hexahydro-1(2H)-azulenone, for example ROTUNDONE-containing materials (for example in the form of AKIGALAWOOD™), clary sage absolute, 3,8,8,11a-tetramethyldodecahydro-1H-3,5a-epoxynaphtho[2,1-c]oxepine, for example AMBERKETAL™, 2-(3,8-dimethyl-1,2,3,4,5,6,7,8-octahydroazulen-5-yl)propan-2-yl acetate, for example GUAIYL ACETATE, (E)-1-(2,6,6-trimethylcyclohexa-1,3-dien-1-yl)but-2-en-1-one, for example DAMASCENONE, 2-(2-(3,3,5-trimethylcyclohexyl)acetyl)cyclopentanone, for example DIONE, 4-ethyloctanoic acid, dimethyl sulphide, 2,4-diethoxy-5-methylpyrimidine, for example VETHYMINE™, iso-propyl-2-methyl-4-thiazole, pine oil (in particular Siberian pine oil), 2-(4-methylcyclohex-3-en-1-yl)propan-2-ol, for example 4-TERPINEOL, oct-1-en-3-ol, for example AMYL VINYL CARBINOL, 8a,9,9-Trimethyl-1,2,4a,5,6,7,8,8a-octahydro-1,6-methanonaphthalen-1-ol, for example NOR-PATCHOULENOL, 5-isopropyl-2-methylphenol, for example CARVACROL, 4-hydroxy-3-methoxybenzaldehyde, for example VANILLIN, 4-allyl-2-methoxyphenol, for example EUGENOL, 2-methoxyphenol, for example GUAIACOL, dihydro 4-allyl-2-methoxyphenol, for example EUGENOL, 3-hydroxy-4,5-dimethylfuran-2(5H)-one, for example CARAMEL LACTONE, 4-(1-ethoxyvinyl)-3,3,5,5-tetramethylcyclohexanone, for example KEPHALIS™, fenugreek absolute, immortelle absolute, cistus absolute, flouve absolute, beeswax absolute, dimethyl trisulphide, ethyl 2-methylpentanoate, for example MANZANATE™, 2-methyl propanoic acid, 3-methyl butyric acid, 4-methyl octanoic acid and (Z)-methyl 2-(3-oxo-2-(pent-2-en-1-yl)cyclopentyl)acetate, for example METHYL EPI JASMONATE.

27. A perfume complement according to claim 23 comprising one or more compounds selected from the group consisting of:
8-(sec-butyl)-5,6,7,8-tetrahydroquinoline, for example BIGARYL, carrot seed oil, tea tree oil, 2,3-dimethyl pyrazine, 2,5-dimethyl pyrazine, a black chocolate accord, coffee extract, 5,8a-dimethyl-1,3,4,7,8,8a-hexahydronaphthalen-4a(2H)-ol, for example GEOVERTOL™, (E)-4-methyldec-3-en-5-ol, for example UNDECAVERTOL™, methyl 2,4-dihydroxy-3,6-dimethylbenzoate, for example EVERNYL, 2-(3-phenylpropyl)pyridine, for example CORPS RACINE™, cistus oil, hydrocarboresine, suederal, or other similar leather accords, 1a,3,3,4,6,6-hexamethyl-1a,2,3,4,5,6,7,7a-octahydronaphtho[2,3-b]oxirene, for example MOXALONE™, 2-isobutylquinoline, for example ISOBUTYL QUINOLINE, 2,3,3-trimethyl-2,3-dihydro-1H-inden-1-one, for example SAFRALEINE, birch tar, cade oil, styrax pyrogenated, 2-methoxy-4-methylphenol, for example CREOSOL, cypriol, 3-hydroxy-2-methyl-4H-pyran-4-one, for example MALTOL, 2-ethyl-4-hydroxy-5-methylfuran-3(2H)-one, for example HOMOFURONOL, 2-hydroxy-3-methylcyclopent-2-enone, for example CORYLONE, 2-(4-Methyl-1,3-thiazol-5-yl)ethanoL, for example SULPHUROL™, 2-hydroxy-3,4-dimethyl-2-cyclopenten-1-one, for example METHYL CORYLONE, 4-allyl-2-methoxyphenyl acetate, for example EUGENYL ACETATE, iso-4-allyl-2-methoxyphenol, for example EUGENOL, 2-ethoxy-4-methylphenol, for example ULTRAVANIL, (1R,4R,6R,10S)-4,12,12-Trimethyl-9-methylen-5-oxatricyclo[8.2.0.04,6]dodecan, for example CARYOPHYLLENE OXIDE, 1,3,4,5,6,7-hexahydro-.beta.,1,1,5,5-pentamethyl-2H-2,4a-Methanonaphthalene-8-ethanol, for example AMBERMAX™, (4aR,5R,7aS,9R)-Octahydro-2,2,5,8,8,9a-hexamethyl-4H-4a,9-methanoazuleno[5,6-d]-1,3-dioxole, for example AMBROCENIDE™, amber Xtreme, osmanthus accord, tobacco absolute, hay absolute, bran absolute, 4-methyl valeric acid, isoamyl alcohol, hexanal, hexanol, hexenyl acetate, 2,6,6-trimethylbicyclo[3.1.1]hept-2-ene, for example PINENE ALPHA, 6,6-dimethyl-2-methylenebicyclo[3.1.1]heptane, for example PINENE BETA, 4-methylene-1-(1-methylethyl)bicyclo[3.1.0]hexane, for example SABINENE, 7-methyl-3-methyleneocta-1,6-diene, for example MYRCENE, non-2-enal, cis 3-hexanol, methyl isoamyl ketone, 2-methyl butyric acid, castoreum base, indole, 3-methyl-1H-indole, for example SKATOLE, p-cresol, p-cresyl acetate, costus olifacc, 6-methyl-5-hepten-2-one, 2,6,6-Trimethyl-1-cyclohexene-1-carbaldehyde, for example BETA CYCLOCITRAL, (E)-4-(2,6,6-trimethylcyclohex-1-en-1-yl)but-3-en-2-one, for example IONONE BETA, methyl nonyl ketone and methyl heptyl ketone.

28. A perfume complement comprising at least one Group A compound and/or at least one Group B, and/or at least one Group C, and/or at least one Group D and/or at least one Group E compound, wherein
Group A—
(i) 2-methoxy-3,6-dimethypyrazine,
(ii) 2-isopropyl-3-methoxy pyrazine, 2-isobutyl-3-methoxy pyrazine,
(iii) 2,4-diethoxy-5-methylpyrimidine, for example VETHYMINE™, iso-propyl-2-methyl-4-thiazole, Siberian pine oil, 2-(4-methylcyclohex-3-en-1-yl)propan-2-ol, for example 4-TERPINEOL, 2-methoxy-3,5-dimethypyrazine, 2-methoxy-5,6-dimethylpyrazine, 2-isopropyl-5-methoxy pyrazine, 2-isopropyl-6-methoxy pyrazine, 2-sec-butyl-3-methoxy pyrazine and 2-butyl-3-methoxy pyrazine,
(iv) 8-(sec-butyl)-5,6,7,8-tetrahydroquinoline, for example BIGARYL™, carrot seed oil, tea tree oil, 2,3-dimethyl pyrazine, 2,5-dimethyl pyrazine, a black chocolate accord or a coffee oil obtained by supercritical carbon dioxide extraction.
Group B—
(i) 2-methyl 1,2,7,7-tetramethylbicyclo[2.2.1]heptan-2-ol, for example 2-METHYL ISOBORNEOL, (either of the enantiomers, or their mixtures in any proportion),
(ii) 4,4,8a-trimethyldecahydronaphthalen-4a-ol, for example METHYL GEOSMIN,
(iii) (4S,4aS,8aR)-4,8a-Dimethyl-1,2,3,4,5,6,7,8-octahydronaphthalen-4a-ol, for example GEOSMIN, oct-1-en-3-ol, for example AMYL VINYL CARBINOL, 1,2,7,7-tetramethylbicyclo[2.2.1]heptan-2-ol for example 2-METHYL BORNEOL and 8a,9,9-Trimethyl-1,2,4a,5,6,7,8,8a-octahydro-1,6-methanonaphthalen-1-ol, for example NOR-PATCHOULENOL,
(iv) 5,8a-dimethyl-1,3,4,7,8,8a-hexahydronaphthalen-4a(2H)-ol, for example GEOVERTOL, (E)-4-methyldec-3-en-5-ol, for example UNDECAVERTOL™, methyl 2,4-dihydroxy-3,6-dimethylbenzoate, for example EVERNYL and 2-(3-phenylpropyl)pyridine, for example CORPS RACINE™
Group C—
(i) 3-propyl phenol,
(ii) 4-ethyl phenol,
(iii) 4-Ethenyl-2-methoxyphenol, for example 4-VINYL GUAIACOL, 2,6,6-trimethylcyclohexa-1,3-dienecarbaldehyde, for example SAFRANAL, 4-vinyl phenol, 4-, 4-propyl phenol and 3-ethyl phenol,
(iv) Cistus oil, hydrocarboresine, suederal(IFF)(or leather accord), 1a,3,3,4,6,6-hexamethyl-1a,2,3,4,5,6,7,7a-octahydronaphtho[2,3-b]oxirene, for example MOXALONE™ 2-isobutylquinoline, for example ISOBUTYL QUINOLINE, 2,3,3-trimethyl-2,3-dihydro-1H-inden-1-one, for example SAFRALEINE, birch tar, cade oil, styrax pyrogenated and 2-methoxy-4-methylphenol, for example CREOSOL,
Group D—
(i) (3S,5R,8S)-5-Isopropenyl-3,8-dimethyl-3,4,5,6,7,8-hexahydro-1(2H)-azulenone, for example ROTUNDONE, clary sage absolute, 3,8,8,11a-tetramethyldodecahydro-1H-3,5a-epoxynaphtho[2,1-c]oxepine, for example AMBERKETAL™
(ii) 2-(3,8-dimethyl-1,2,3,4,5,6,7,8-octahydroazulen-5-yl)propan-2-yl acetate, for example GUAIYL ACETATE, (E)-1-(2,6,6-trimethylcyclohexa-1,3-dien-1-yl)but-2-en-1-one, for example DAMASCENONE, 2-(2-(3,3,5-trimethylcyclohexyl)acetyl)cyclopentanone, for example DIONE
(iii) 4-hydroxy-3-methoxybenzaldehyde, for example VANILLIN, 4-allyl-2-methoxyphenol, for example EUGENOL, 2-methoxyphenol, for example GUAIACOL, dihydro 4-allyl-2-methoxyphenol, for example EUGENOL, 3-hydroxy-4,5-dimethylfuran-2(5H)-one, for example CARAMEL LACTONE™, 4-(1-ethoxyvinyl)-3,3,5,5-tetramethylcyclohexanone, for example KEPHALIS™, fenugreek absolute, immortelle absolute, cistus absolute, flouve absolute and beeswax absolute,
(iv) Cypriol oil, 3-hydroxy-2-methyl-4H-pyran-4-one, for example MALTOL, 2-ethyl-4-hydroxy-5-methylfuran-3(2H)-one, for example HOMOFURONOL, 2-hydroxy-3-methylcyclopent-2-enone, for example CORYLONE, 2-(4-Methyl-1,3-thiazol-5-yl)ethanoL, for example SULPHUROL™, 2-hydroxy-3,4-dimethyl-2-cyclopenten-1-one, for example METHYL CORYLONE, 4-allyl-2-methoxyphenyl acetate, for example EUGENYL ACETATE, iso-4-allyl-2-methoxyphenol, for example EUGENOL, 2-ethoxy-4-methylphenol, for example ULTRAVANIL™, (1R,4R,6R,10S)-4,12,12-Trimethyl-9-methylen-5-oxatricyclo[8.2.0.04,6]dodecan, for example CARYOPHYLLENE OXIDE, 1,3,4,5,6,7-hexahydro-.beta., 1,1,5,5-pentamethyl-2H-2,4a-Methanonaphtha lene-8-ethanol, for example AMBERMAX™, (4aR,5R,7aS,9R)-Octahydro-2,2,5,8,8,9a-hexamethyl-4H-4a,9-methanoazuleno[5,6-d]-1,3-dioxole, for example AMBROCENIDE™, 1-(2-tert-butylcyclohexyl)oxybutan-2-ol, for example AMBER XTREM™, osmanthus accord, tobacco absolute, hay absolute and bran absolute,
Group E—
(i) 4-ethyloctanoic acid, dimethyl disulphide,
(ii) ethyl 4-methylvalerate, dimethyl trisulphide,
(iii) ethyl 2-methylpentanoate, for example MANZANATE™, 2-methylpropanoic acid, 3-methyl butyric acid, 4-methyloctanoic acid and (Z)-methyl 2-(3-oxo-2-(pent-2-en-1-yl)cyclopentyl)acetate, for example METHYL EPI JASMONATE,
(iv) 4-methylvaleric acid, isoamyl alcohol, hexanal, hexanol, cis-3-hexenyl acetate, alpha-pinene, beta-pinene, 4-methylene-1-(1-methylethyl)bicyclo[3.1.0]hexane, for example SABINENE, 7-methyl-3-methyleneocta-1,6-diene, for example MYRCENE, non-2-enal, cis 3-hexenol, 5-me-hexan-2-one (methyl isoamyl ketone), 2-methyl butyric acid, Castoreum base, indole, 3-methyl-1H-indole, for example SKATOLE p-cresol, p-cresyl acetate, costus oliffac(IFF), 6-me-5-hepten-2-one, 2,6,6-Trimethyl-1-cyclohexene-1-carbaldehyde, for example BETA CYCLOCITRAL, beta-ionone, undecan-2-one(methyl nonyl ketone) and nonan-2-one (methyl helptyl ketone).

29. A perfume complement according to claim 28 comprising:
at least one compound from Group A(i), at least one compound from Group B(i), at least one compound from Group C(i), at least one compound from Group D(i) and at least one compound from Group E(i),
or,
at least one compound from Group A(ii), at least one compound from Group B(ii), at least one compound from Group C(ii), at least one compound from Group D(ii) and at least one compound from Group E(ii).

30. A perfume complement according to claim 28 comprising:
all of A(i), all of B(i), all of C(i), all of D(i) and all of E(i)
or
all of A(ii), all of B(ii), all of C(ii), all of D(ii) and all of E(ii).

31. A perfume complement according to claim 28 comprising:
all of A(i), all of B(i), all of C(i), all of D(i) and all of E(i), and all of A(ii), B(ii), C(ii), D(ii) and E(ii).

32. A perfume complement according to claim 21 comprising:
at least one compound selected from the groups consisting of A(iii), B(iii), C(iii), D(iii) and E(iii) and/or
at least one compound selected from any one of Groups A(iv), B(iv), C(iv), D(iv) and E(iv).

33. A perfume complement according to claim 12 comprising all of A(iv), B(iv), C(iv), D(iv) and E(iv).

34. A fragrance formulation comprising a patchouli extender and a perfume complement as defined claim 1.

35. A fragrance formulation according to claim 34, wherein the patchouli extender is prepared by advanced fermentation, preferably by the action of a sesquiterpene synthase on the terpene precursor substrate farnesyl pyrophosphate (FPP).

36. A fragrance formulation according to claim 34, wherein the patchouli extender is Clearwood™.

37. A method of adapting, modifying or improving the odour of a fragrance formulation, and in particular a patchouli extender, the method comprising the step of adding to the formulation a perfume complement as defined in claim 1.

38. A method according to claim 37, wherein the compounds contained in the perfume complement are added separately, sequentially or simultaneously to the fragrance formulation.

39. A consumer product containing a perfume complement as defined in claim 1.

40. A consumer product containing a fragrance composition as defined in claim 34.
